(19) United States
(12) Patent Application Publication
(10) Pub. No.: US 2006/0126714 A1
(43) Pub. Date: Jun. 15, 2006

(54) Method and apparatus for measuring signal jitters

(75) Inventors: Chun Wei Lin, Changhua (TW); Huo Wen Chen, Yunlin (TW); Raymond Chen, Chiayi (TW)

Correspondence Address: OLIFF & BERRIDGE, PLC, P.O. BOX 19928, ALEXANDRIA, VA, 22320, US

(73) Assignee: SPIROX CORPORATION, Hsinchu City (TW)

(21) Appl. No.: 11/293,117

(22) Filed: Dec. 5, 2005

(30) Foreign Application Priority Data
Dec. 15, 2004 (TW) 093138891

(51) Int. Cl. H04B 17/00

(52) U.S. Cl. 375/226

(57) ABSTRACT

A measuring method for signal jitter comprises the following procedures: First, a first data signal is provided, and the first data signal is deemed equivalent to a second data signal, wherein frequency of the first data signal is a multiple (preferably odd) of that of the second data signal, and at the same time, the ascent and the descent edges of the second data signal are the same as that of the first data signal. The widths of the high and low levels of the second data signal are counted so as to generate an estimated jitter stream including the estimated jitter values of the ascent and the descent edges of the second data signal. Then, jitter distribution diagrams of the ascent and the descent edges are established based on the estimated jitter stream, so as to calculate an eye open (EO) value.

### BACKGROUND OF THE INVENTION

(A) Field of the Invention

The present invention relates to a measuring method and apparatus for signal jitter, especially to a method and apparatus for measuring the jitter of high-speed signals.

(B) Description of the Related Art

Jitter is defined as a time deviation of the actual position of the signal edge compared to its ideal position, also called timing distortion, which is caused by thermal or electromagnetic noise, unstable circuits or transmission loss. For a data transportation system, jitter will result in errors in data transmission, and further impair the entire reliability of the system.

Jitter can be divided into deterministic jitter and random jitter. Random jitter is essentially a Gaussian distribution, which is generally caused by factors such as thermal noise, shot noise, etc. The deterministic jitter contains Periodic Jitter (PJ), Data Dependent Jitter (DDJ), Duty Cycle Distortion (DCD), etc. PJ is generally in the form of a sinusoid; DDJ is usually caused by some factors that change data, such as Inter-Symbol Interference (ISI) of the bandwidth limit of the system, while DCD results from voltage offset among differential signals and the time difference between the ascent and descent of the system. Total jitter is the sum of the deterministic jitter and the random jitter.

Commonly used methods to measure jitter include Eye diagram and Time Interval Error (TIE) statistical charts, both of which offer associated information about total jitter. Other measuring methods, such as spectral analysis, can provide a more detailed understanding of different jitter components.

As shown in FIG. 1, an eye diagram 15 is acquired by covering the ascent and the descent edge 11 of a series of pulses received by a sensor on the high-speed oscillograph, namely overlapping each pulse. The eye diagram is so named since the shape is similar to an eye, and a larger eye opening (EO) value indicates a better transmission quality. On the contrary, “narrow eye” indicates an inferior signal quality. Thus, quality of the signal can be verified by comparing the mask 12 of the eye diagram with the mask of a standard eye diagram.

A TIE statistical chart is used to count the error amount of time between actual and ideal jitter, which can show the scattering phenomena caused by the deterministic jitter component and the random jitter component.

However, for the measurement of jitter, a mistake may be produced since an ideal reference signal source cannot be generated and the measured value is magnified by an additionally incorporated jitter amount, as shown in FIG. 2. In addition, the statistical characteristics of the jitter signal are not liable to convergence, which will result in measuring distortion. For hardware implementation, there are numerous limitations in the design and manufacture of high-speed signals. For example, when a high-speed signal passes through the inverter chain, the signal inverted by the inverter does not have time to respond due to high speed, thus the transmitted signal delays and the signal cannot be identified. Therefore, the art to measure jitter accurately at a lower speed has not yet achieved a breakthrough.

### SUMMARY OF THE INVENTION

The main objective of the present invention is to provide a method and apparatus for measuring signal jitters, which can be built in a chip, characterized by accuracy and low speed, and which is particularly applicable to measure high-speed signals.

To achieve the above objective, a method to measure signal jitter is disclosed, which contains the following procedures. A first data signal is provided, and the first data signal is deemed equivalent to a second data signal, wherein frequency of the first data signal is a multiple (preferably odd) of that of the second data signal, and at the same time, the ascent and the descent edges of the second data signal are the same as that of the first data signal. The widths of the high and low levels of the second data signal are counted so as to generate an estimated jitter stream including the estimated jitter values of the ascent and the descent edges of the second data signal. Then, jitter distribution diagrams of the ascent and the descent edges are established based on the estimated jitter stream, so as to calculate an EO value.

High and low level widths of the second data signal can be measured based on two clock signals, and pulse widths of the two clock signals cover the high level and low level of the second data signal, respectively.

In addition, after the EO value is obtained, high and low boundary detection thresholds of the second data signal can be selected, by which jitter distribution diagrams of corresponding ascent and descent edges can be generated. Then, the ranges of the jitter distribution diagrams of the ascent and descent edges are calculated in light of the high and low boundary detection threshold; such ranges are deemed the top and bottom ranges of the ascent and descent lines of an eye diagram. Thus, the scope of the mask in the eye diagram can be defined clearly.

The above-mentioned signal jitter method can be implemented by means of an apparatus for measuring signal jitters, which contains a modulator, a delay cell, two delay lines, two encoders and a latch. The two delay lines are connected in parallel to delay and quantify the first data signal. The two encoders are connected to the two delay lines in series respectively to calculate the high and low level widths of the second data signal. The latch is employed to pick up the outputs of the two encoders alternately.

The above-mentioned apparatus for measuring the signal jitters can additionally contain a modulator to produce a first signal and a second clock signal that input the two delay lines respectively, and the pulse widths of the first and second clock signals can cover the high and low levels of the data signal respectively in order to calculate the clock of the high and low level widths of the data signal.

### BRIEF DESCRIPTION OF THE DRAWINGS

The present invention will be described according to the appended drawings in which:

FIG. 1 is a known eye diagram;

FIG. 2 shows a known method for measuring signal jitters;

FIGS. 3 to 4 show the photographic technology in measuring signal jitters of the present invention;

FIGS. 5 (a) and (b) show boundary detection thresholds of a data signal;

FIG. 6 shows an eye diagram and relations among associated jitter distribution diagrams;

FIGS. 7 to 10 show related technologies to the signal jitter measuring method of the present invention;

FIG. 11 illustrates the measuring apparatus for signal jitters of the present invention;

FIG. 12 exemplifies a known eye diagram of a data signal;

FIG. 13 shows the relation between a data signal and clock signals of an embodiment of the measuring method for signal jitters of the present invention;

FIG. 14 and FIG. 15 illustrate a known jitter distribution histogram and a jitter distribution histogram obtained according to the present invention;

FIG. 16 and FIG. 17 illustrate jitter distribution histograms obtained by different boundary detection thresholds;

FIG. 18 illustrates an eye diagram obtained by the measuring method for signal jitter of the present invention;

FIG. 19 illustrates another measuring apparatus for signal jitters of the present invention;

FIG. 20 is a delay line of the measuring apparatus for signal jitters of the present invention;

FIGS. 21 to 24 are employed to describe the pipeline of the delay line of the measuring apparatus for signal jitters of the present invention; and

FIG. 25 and FIG. 26 are employed to describe the calibration mode of the delay line of the measuring apparatus for signal jitters of the present invention.

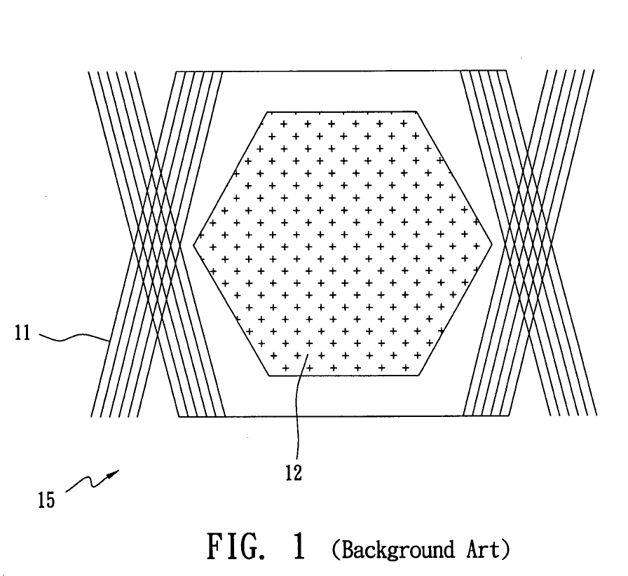

### DETAILED DESCRIPTION OF THE PRESENT INVENTION

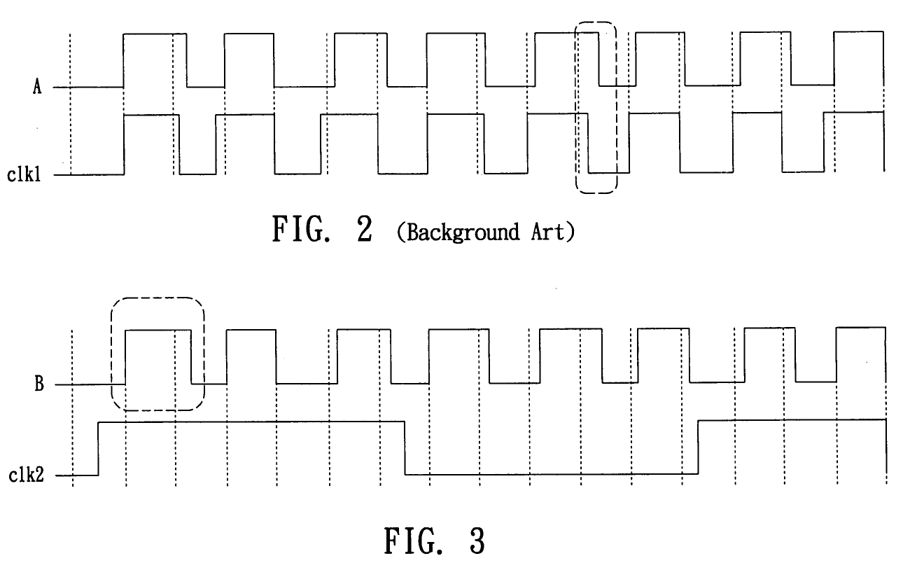

Referring to FIG. 2 again, in which a known method for measuring signal jitters is shown, the frequency of a high-speed data signal A is denoted by f, and the clock signal clk1 with the same frequency f is employed to measure the jitter of the data signal A. If the clock signal with high accuracy, having errors lower than 2 picoseconds, is desired at a high speed, some special processes such as silicon and germanium processes have to be generally used. If clk1 is produced with a current silicon process, jitter aliasing of the clk1 and the data signal A as shown in FIG. 2 (the dashed frame) will occur more likely at high speed, so that jitter measuring accuracy decreases greatly.

Referring to FIG. 3, jitters of a data signal B of a frequency f are measured at lower speed using a clock clk2 of a frequency f/3. This method is like photographic technology, the clk2 signal with longer periods covering the entire pulse width of data signal B whereby the width of the pulses of data signal B can be obtained directly, so as to eliminate the above-mentioned jitter aliasing.

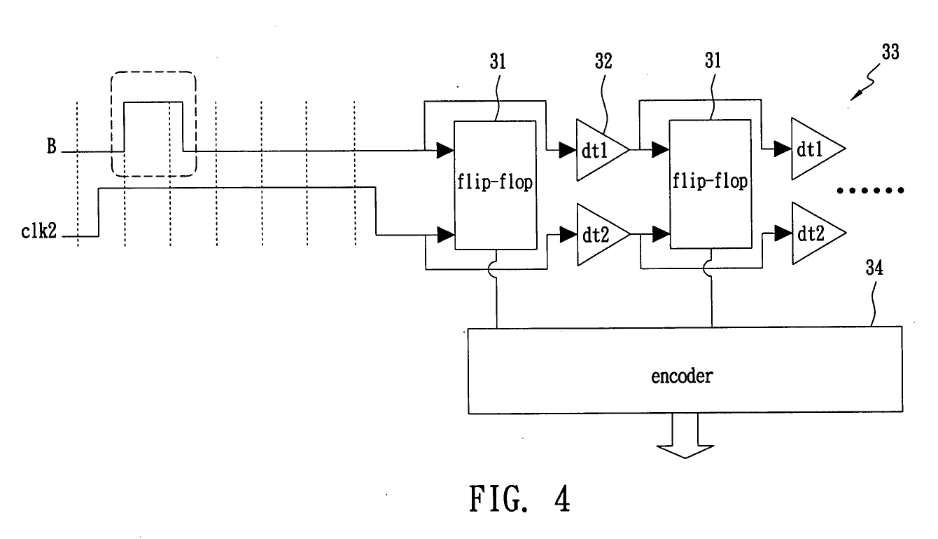

Referring to FIG. 4, the data signal B and clk2 signal in FIG. 3 go through a delay line 33 and an encoder 34 so as to calculate the proportion of “0” and “1” of the signal B, i.e., the high and low level widths of data signal B. The delay line 33 consists of a plurality of flip-flops 31 and buffers 32 in series.

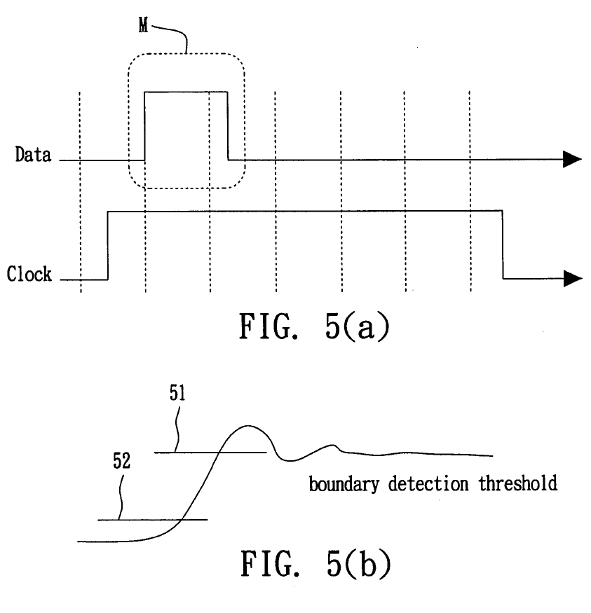

Referring to FIG. 5(a), the toggling of the data signal from “0” to “1” (or from “1” to “0”) is not a pure switchover, in fact, but the graph as shown in FIG. 5(b) (enlarged diagram “M” in FIG. 5(a)), and the changing slope affects the slopes of the ascent and descent edges of the pulse in a corresponding eye diagram. Therefore, sampling points of voltage from “0” to “1” or from “1” to “0” are generally set on high and low boundary detection thresholds 51 and 52 to compute the top and bottom span of the ascent and descent line of the corresponding eye diagram.

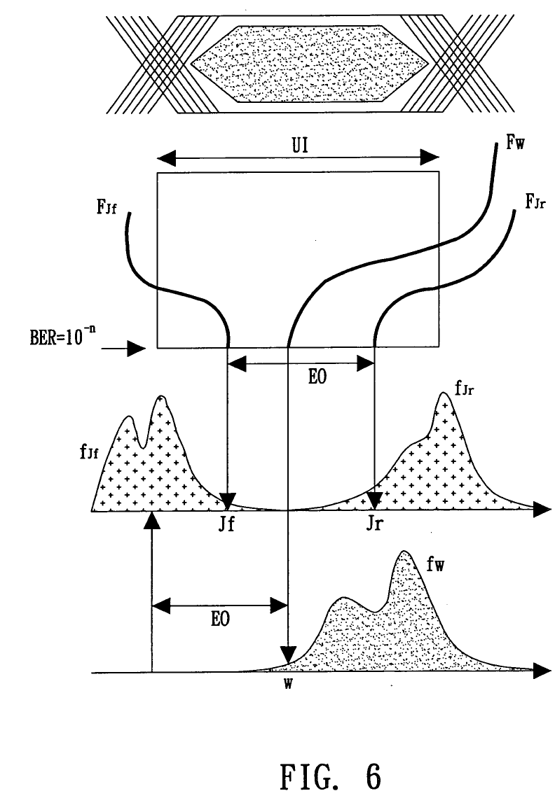

FIG. 6 shows an eye diagram and relations among associated curves. Regardless of jitter accuracy, the jitter distribution diagrams (Probability Density Function, PDF) f_{Jr} and f_{Jf} obtained on ascent and descent edges of the pulses are accumulated, thereby generating a Cumulative Density Function (CDF) curve F_{Jr} and F_{Jf} in a Nominal Interval (UI), and the width between F_{Jr} and F_{Jf} corresponding to a bit error rate (BER) of 10⁻ⁿ is the Eye Opening (EO) value as shown in FIG. 6.

However, based on the consideration of jitter accuracy of a high-speed signal, the distribution diagram of jitter cannot be obtained directly. An EO value, therefore, is calculated by the following method in this invention.

Similarly, several pulses are handled with the method shown in FIG. 3 and FIG. 4, and the width distribution fw is shown in the lower diagram of FIG. 6. Known from the analysis of the formula (1): the EO value is the value of the Fw when BER is 10⁻ⁿ, so that the EO value can also be calculated based on the pulse widths of the data signal.

$$\begin{matrix}EO = UI - Jr {{\vert}_{{\int }_{Jr}^{∞} {f}_{Jr} ( J ) ⅆ J = {10}^{- n}} - ( UI - Jf ) \vert}_{{\int }_{- ∞}^{Jf} {f}_{Jf} ( J ) ⅆ J = {10}^{- n}} \\ = Jf - Jr {\vert}_{P ( Jr \leq J \leq Jf ) = {10}^{- n}} \\ = w {{\vert}_{P ( W \leq w ) = {10}^{- n}} = w \vert}_{{F}_{w} = {10}^{- n}}\end{matrix} \qquad ( 1 )$$

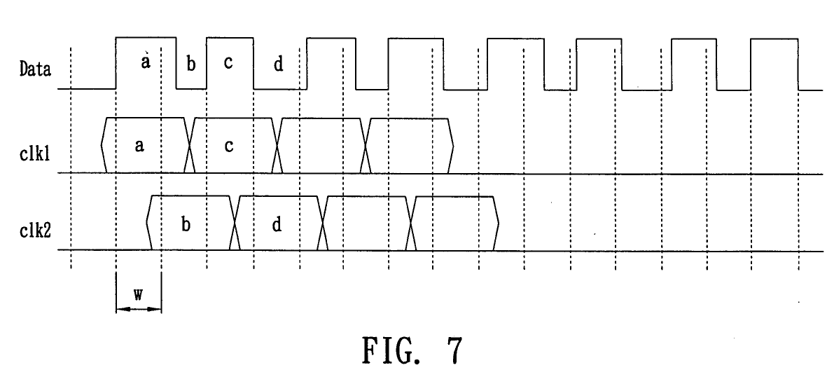

Referring to FIG. 7, it is given that jitters of the data signal at positions a, b, c, d, etc., are j1, j2, j3, j4 . . . jn in turn. For example, the left and right jitter of position a are j1 and j2, whereas the left and right jitter of position b are j2 and j3. Thus, if the ideal equal space width is w, the data signal width W_data[a] of position a will be w+(j2−j1), and the data signal width W_data[b] of position b is w+(j3−j2), and so on:

$$\begin{matrix}W\_data [ a ] = w + ( j2 - j1 ) ; \\ W\_data [ b ] = w + ( j3 - j2 ) ; \\ W\_data [ c ] = w + ( j4 - j3 ) ; \\ ⋮\end{matrix}$$

Assume another jitter in series j1′=j1−j1=0;

$$\begin{matrix}{j2}^{′} = W\_data [ a ] - w + {j1}^{′} = j2 - j1 ; \\ {j3}^{′} = W\_data [ b ] - w + {j2}^{′} = j3 - j1 ; \\ {j4}^{′} = W\_data [ c ] - w + j3 = j4 - j1 ;\end{matrix}$$

$$⋮$$

Therefore, the jitter stream consisting of j1′, j2′ and j3′. . . jn′ is respectively equal to 0, j2−j1, j3−j1 . . . jn−j1, i.e., there is an offset of j1 between this jitter stream and the original one. The jitter stream consisting of j1′, j2′ and j3′. . . jn′ is called estimated jitter stream here.

Two clocks clk1 and clk2 respectively cover the high level of positions a and c and the low level of positions b and d to calculate the high and low level widths of the data signal at positions a, b, c, d, etc.

According to the offset characteristic of the above two jitter streams, the obtained high and low level widths are deemed as values of above-mentioned W_data[a], W_data[b], etc., so as to calculate corresponding estimated jitter values j1′, j2′, j3′. . . jn′, even if the actual jitter stream of j1, j2, j3, j4 . . . jn is unknown.

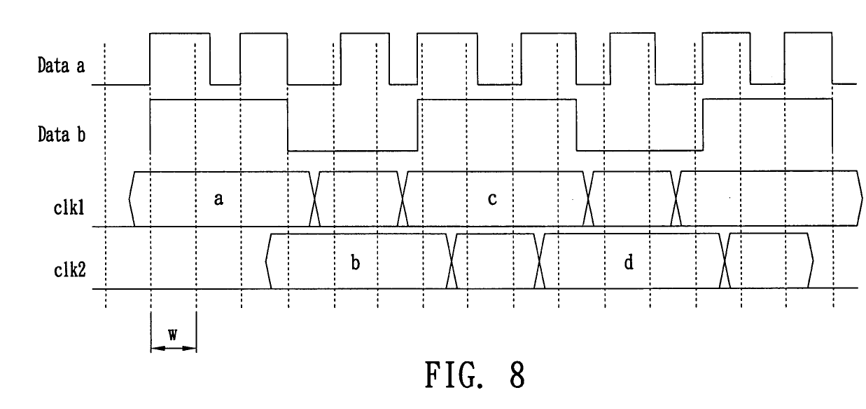

Referring to FIG. 8, for the rate problem of the clock to measure a high-speed signal, a data signal a of the frequency f is deemed as being equivalent to a data signal b with descent tripled frequency, i.e., the data signal b of frequency f/3. For instance, the ascent edge of a pulse and the descent edge of the next pulse of the data signal a are regarded as the ascent and descent edge of a pulse of the data signal b. In other words, the ascent edge of the data signal b aligns with that of the data signal a. Similarly, two clocks clk1 and clk2 with frequencies of f/3, in which clk1 covers the high levels of positions a and c of the data signal b and clk2 covers the low levels of positions b and d, are employed to obtain the high and low level widths of the data signal b. In the same way, if an ideal equal space width is w, the data signal width W_data[a] at position a is actually 3w+(j4−j1), and the data signal width W_data[b] at position b is 3w+(j7−j4), and so on:

$$\begin{matrix}W\_data [ a ] = 3 w + ( j4 - j1 ) ; \\ W\_data [ b ] = 3 w + ( j7 - j4 ) ; \\ W\_data [ c ] = 3 w + ( j10 - j7 ) ;\end{matrix}$$

$$⋮$$

Thus the estimated jitter stream of j1′, j4′, j7′, etc., is:

$$\begin{matrix}{j1}^{′} = j1 - j1 = 0 ; \\ {j4}^{′} = W\_data [ a ] - 3 w + {j1}^{′} = j4 - j1 ; \\ {j7}^{′} = W\_data [ b ] - 3 w + {j4}^{′} = j7 - j1 ;\end{matrix}$$

$$⋮$$

The data signal b and data signal a may have other multiple frequency relations; however, the odd multiple is preferred to match signal ascent and descent. In the case of an even multiple, it is still necessary to convert the signal into an essentially odd multiple to process. If there is a k multiple frequency difference between data signal a and data signal b, duty cycles of clk1 and clk2 are (k+1)/2k and (k−1)/2k, respectively.

If there is a systematic error δ in the system,

$$\begin{matrix}W\_data [ a ] = w + ( j2 - j1 ) + δ = ( w + δ ) + ( j2 - j1 ) ; \\ W\_data [ b ] = ( w + δ ) + ( j3 - j2 ) ; \\ W\_data [ c ] = ( w + δ ) + ( j4 - j3 ) ;\end{matrix}$$

$$⋮$$

Hence, the estimated jitter stream is:

$$\begin{matrix}{j1}^{′} = 0 ; \\ {j2}^{′} = W\_data [ a ] - w + {j1}^{′} = j2 - j1 + δ ; \\ {j3}^{′} = W\_data [ b ] - w + {j1}^{′} = j3 - j1 + 2 δ ;\end{matrix}$$

$$⋮$$

Thus, if there is a systematic error, error accumulation will occur in the jitter stream, and the accuracy rate decreases.

$$\begin{matrix}If {T}_{1} = W\_data [ a ] + W\_data [ b ] ; \\ {T}_{2} = W\_data [ c ] + W\_data [ d ] ;\end{matrix}$$

$$⋮$$

the mean value Wₐᵥₑ of all W_data will be obtained by dividing the sum of all T1, T2, etc., by 2.

Thus, the estimated jitter stream can be expressed as below:

$$\begin{matrix}{j1}^{′} = 0 ; \\ {j2}^{′} = W\_data [ a ] - {W}_{ave} + {j1}^{′} ; \\ {j3}^{′} = W\_data [ b ] - {W}_{ave} + {j2}^{′} ; \\ {j4}^{′} = W\_data [ c ] - {W}_{ave} + {j3}^{′} ;\end{matrix}$$

$$⋮$$

which represents that the accuracy of the estimated jitter stream can be increased by subtracting the systematic error δ.

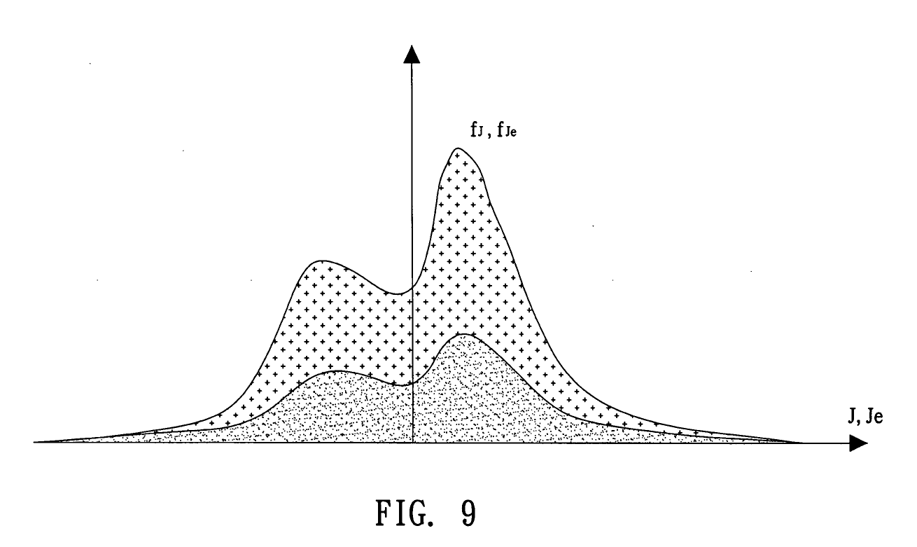

Referring to FIG. 9, this shows the relation between the actual jitter distribution f_{J} counted by j1, j2, j3, etc., of the actual jitter stream multiplied by the sample number and the estimated jitter distribution f_{Je} counted by j1′, j4′, j7′, etc., of the estimated jitter stream multiplied by the sample number, where the abscissa represents actual jitter value J and estimated jitter value Je. The sample number contained in the estimated jitter stream is about one-third of the actual jitter sample number; therefore the height of the distribution sample number of the estimated jitter stream is lower. However, if the time is extended three times, the same distribution sample number will be obtained.

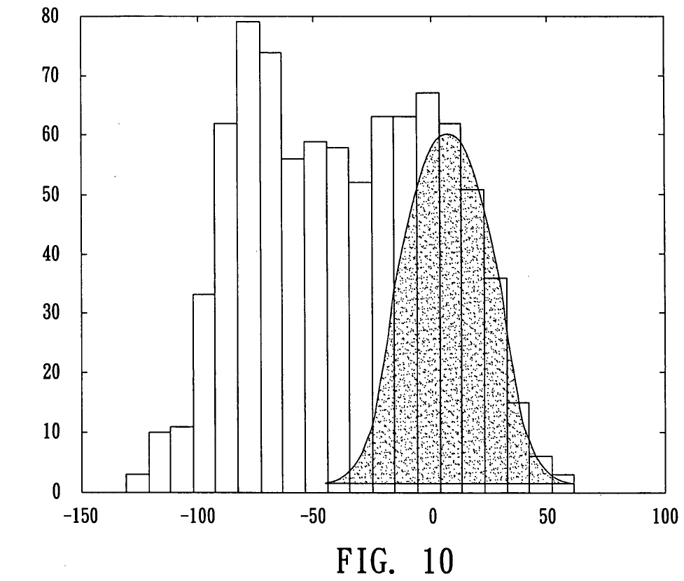

Referring to FIG. 10, the distribution diagram in FIG. 9 is converted into a jitter distribution histogram, and a Gaussian distribution fits one edge of the jitter distribution histogram. Given that the total sample number of the jitter distribution histogram is n, and the central value of the Gaussian distribution is μ, the probability 0.0228 of Gaussian distribution greater than two times the standard deviation, which can be obtained from a look-up table, is a/n, where a is the sample number when Gaussian distribution is greater than twice the standard deviation. The probability 0.1587 greater than one time of the standard deviation is b/n, where b is a sample number when Gaussian distribution is greater than one time of the standard deviation. The above-mentioned relation can be expressed by the formulae (2) and (3), where x is the value on the abscissa.
P(x>μ+2σ)=0.0228=a/n (2)
P(x>μ+σ)=0.1587=b/n (3)

For n=10000, a is equal to 228, xa value for which more than 228 sample numbers on the abscissa can be found. In addition, b is equal to 1587; xb value can be found in the same way. Accordingly, xa=μ+2σ, xb=μ+σ, therefore σ=xa−xb.

The Bit Error Rate (BER) and the corresponding standard deviation are counted from formulae, and the relation between them can be approximately summarized in Table 1.

TABLE 1

| BER | Standard deviation value |
|---|---|
| 1.3 × 10⁻³ | 6 × σ |
| 3.17 × 10⁻⁵ | 8 × σ |
| 2.87 × 10⁻⁷ | 10 × σ |
| 9.87 × 10⁻⁹ | 12 × σ |
| 1.28 × 10⁻¹² | 14 × σ |
| 1 × 10⁻¹² | 14.069 × σ |

One standard deviation would be reached only when the area difference between the Gaussian distribution and the jitter distribution histogram is about 10000 times, while the actual area difference between them is several times at most, and normally BER value is lower than 10⁻¹² (approximately 14 times the standard deviation) approximately. Therefore, the standard deviation difference between the statistical value of the Gaussian distribution and the jitter distribution histogram is quite small, so that the jitter distribution histogram can be replaced with the Gaussian distribution, and the difference between them can be omitted.

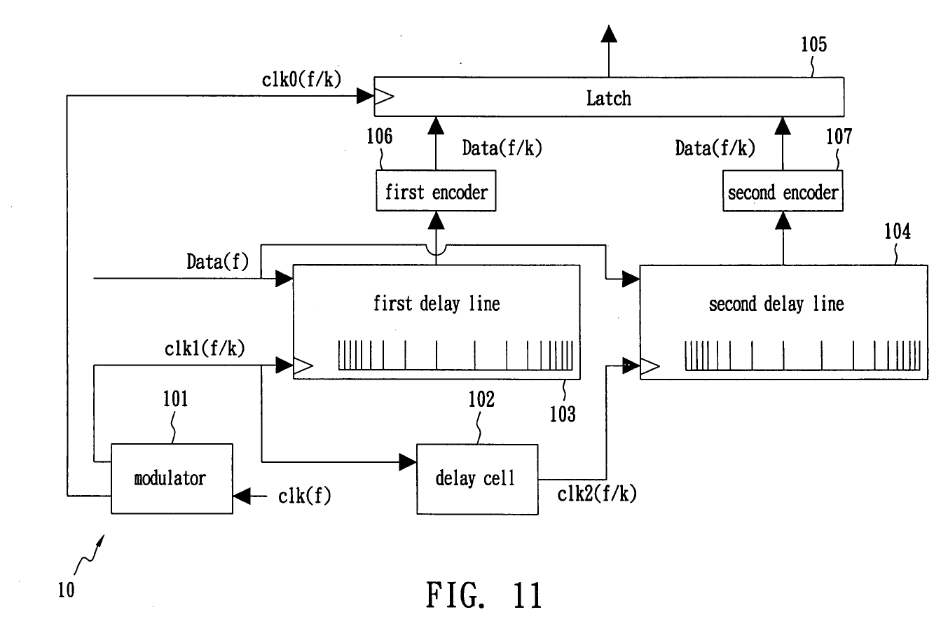

FIG. 11 illustrates a signal jitter measuring apparatus of this invention. An apparatus 10 for measuring signal jitter comprises a modulator 101, a delay cell 102, a first delay line 103, a second delay line 104, a first encoder 106, a second encoder 107 and a latch 105. Two signals, clk0 and clk1 of frequency f/k, are generated based on a clock signal clk of frequency f modulated through the modulator 101 (in the above embodiment, k is equal to 3), where the signal clk1 further goes through the delay cell 102 to generate a signal clk2. A data signal of frequency f is transmitted into the first and second delay lines 103 and 104 so as to reduce the frequency to f/k. The pulse width of the clocks clk1 and clk2 can cover the high and low levels of the data signal of frequency f/k. The latch 105 locks the output signals of the encoders 106 and 107 alternately. The first and second delay line 103 and 104 can be gradient delay lines, i.e., the scale is denser at both ends, while sparser in the middle, by which the sampling number is reduced and the accuracy is improved. The first and second encoder 106 and 107 receive the output signals of the first and second delay lines 103 and 104, and calculate the high and low level widths of the data signal of frequency f/k by means of the clocks clk1 and clk2.

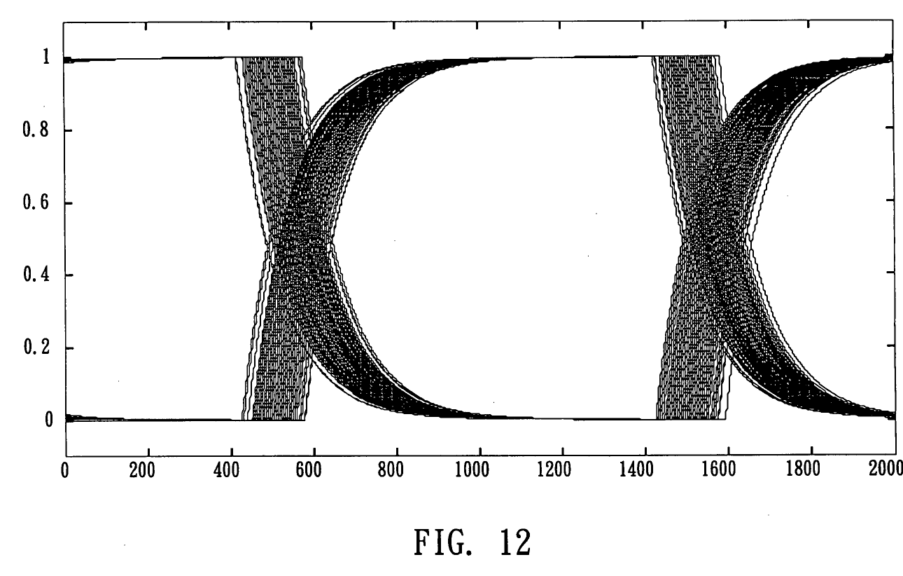

Given the mean value of the random jitter of a known data signal μ=0, σ=17.2 ps, and PJ=50 ps, the frequency of which is 5 MHz, Duty Cycle Distortion (DCD) on both the signal ascent edge and descent edge is 70 ps, and the corresponding eye diagram is shown in FIG. 12.

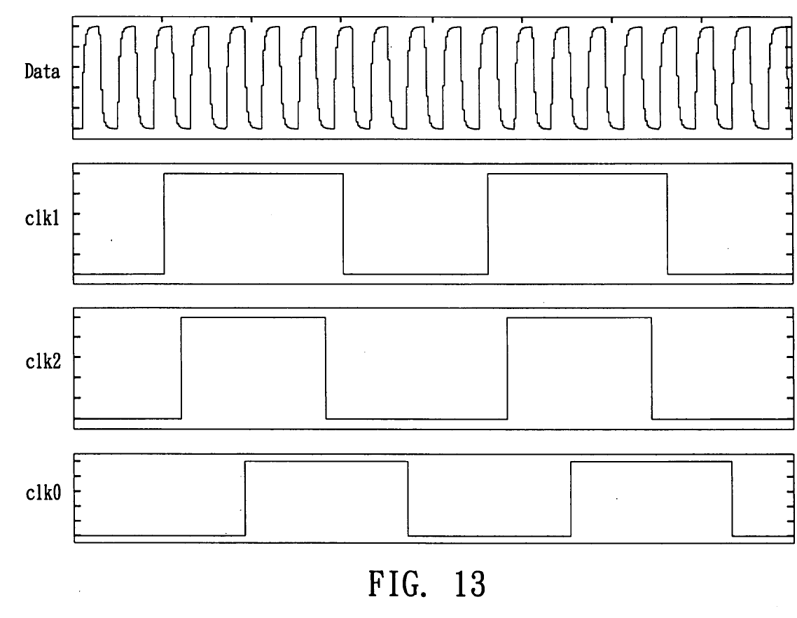

The data signal of 1 Gbps is processed herein by a clock clk of a frequency 1/9 Gbps, in which mean value of the random jitter consists of μ=0, σ=17.2 ps, and PJ=50 ps, the frequency of which is 5/9 MHz. After the above-mentioned data signal and the clock clk are processed by the apparatus 10 shown in FIG. 11, the corresponding clock signals clk0, clk1 and clk2 decrease the frequencies to be 1/9 of the original frequencies, as shown in FIG. 13.

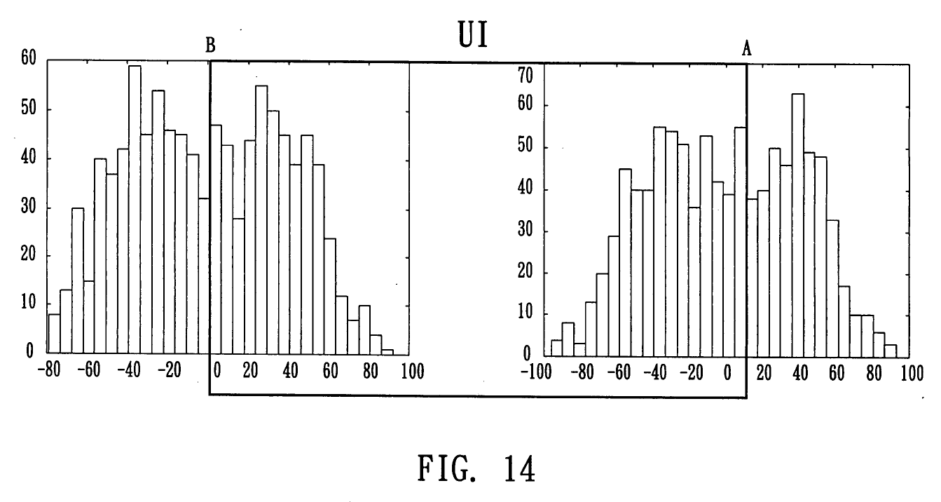

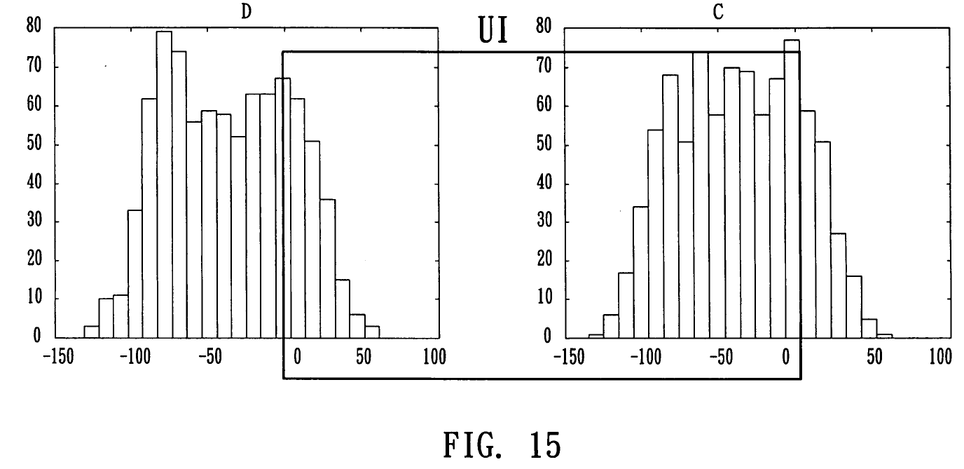

FIG. 14 shows a jitter distribution histogram obtained by accumulation in FIG. 13, in which the distribution diagram B on the left of UI fits the descent profile by means of Gaussian distribution, whereas the distribution diagram A on the right fits the ascent profile by Gaussian distribution. As a result, an EO value can be acquired through the following calculation, given that BER is about 10⁻¹², i.e., corresponding to 14σ (7σ each on the left and the right) in Table 1.

In distribution diagram A, σ=|−66−(−42)|=24, hence the corresponding value of 7σ on the abscissa is −186(−66−24×5=−186);

In distribution diagram B, σ=|71−(45)|=26, hence the corresponding value of 7σ on the abscissa is 201(7σ=71+26×5=201);

Because the data signal is 1 Gbps, the rate is 1 ns; while the unit of the jitter is a picosecond, the difference between them is 1000 times. Therefore, if BER is 10⁻¹², the EO value is equal to 0.613 UI (EO=(1000−201−186)/1000=0.613);

FIG. 15 is a jitter distribution histogram obtained by means of the measuring method of this invention, in which diagram D is on the left and diagram C is on the right. The EO value is calculated by the same method as shown in FIG. 14.

In distribution diagram C, σ=|−107−(−82)|=25, hence the corresponding value of 7θ on abscissa is −232(−107−25×5=−232);

In distribution diagram D, σ=|34−10|=24, hence the corresponding value of 7σ on abscissa is 154(7σ=34+24×5=154);

Therefore, if BER is 10⁻¹², the EO value can be counted to be 0.614 UI (EO=(1000−154−232)/1000=0.614).

As shown in FIG. 14 and FIG. 15, the positions of these two jitter histograms have an offset, which is associated with the above-mentioned j1, but the standard deviation and EO value calculated from them are fairly close to each other, indicating the jitter error calculated according to this invention is slight.

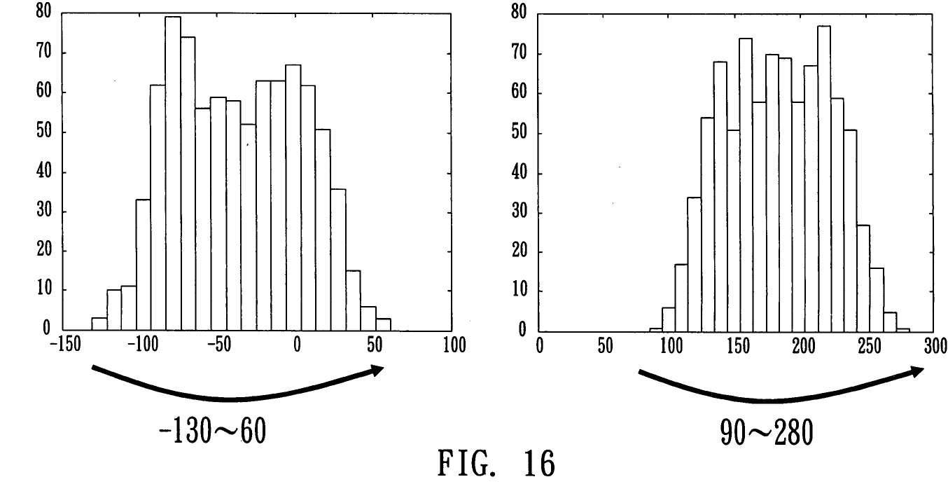

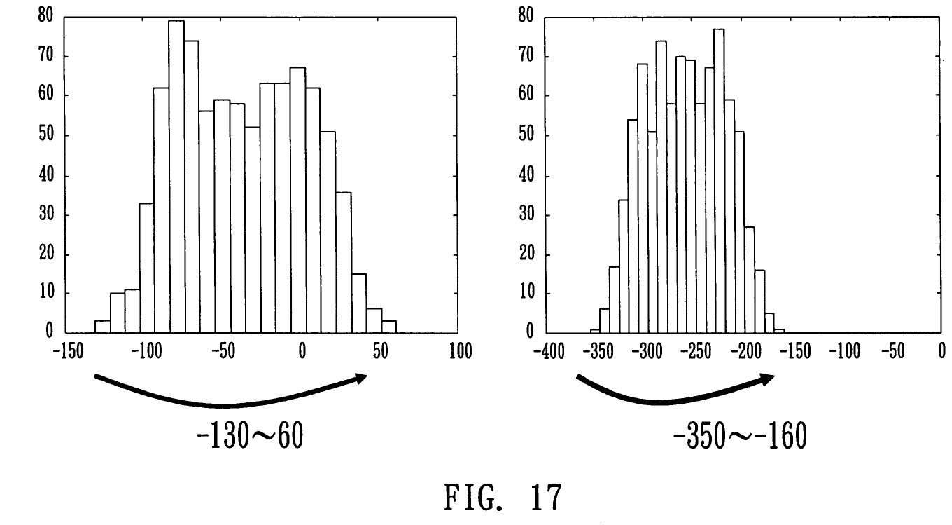

FIG. 14 and FIG. 15 are histograms when the boundary detection threshold is 50%. The left and the right diagrams in FIG. 16 are descent and ascent jitter distribution histograms when the boundary detection threshold is 90%, of which the histogram profile is identical to that shown in FIG. 14, but there is an offset between them. The descent jitter distribution histogram is between −130 and 60, whereas the ascent jitter distribution histogram is between 90 and 280. The left and the right diagrams in FIG. 17 are descent and ascent jitter histograms if the boundary detection threshold is 10%, in which the descent jitter histogram is between −130 and 60, and the ascent jitter histogram is between −350 and −160.

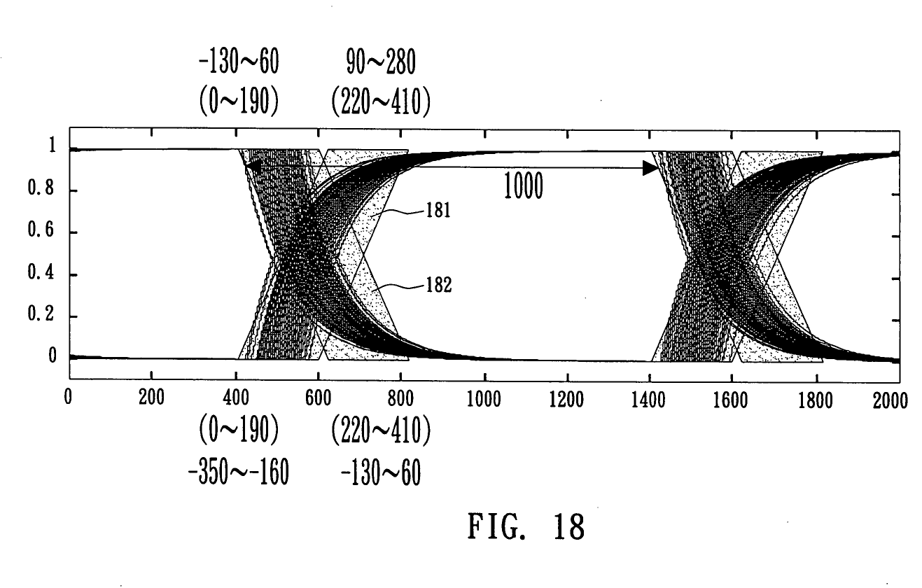

An eye diagram shown in FIG. 18 can be made by means of the ranges of the jitter distribution histograms in FIG. 16 and FIG. 17, in which the ranges of the ascent and descent jitter distribution histograms in FIG. 16 are equal to the ranges of the tops of the ascent line 181 and the descent line 182 of the eye diagram, respectively, whereas the ranges of the ascent and descent jitter distribution histograms in FIG. 17 are equal to the ranges of the bottoms of the ascent line 181 and the descent line 182 of the eye diagram, respectively. If the starting point is reset to zero by offsetting, the ranges of the bottom and the top of the ascent line 181 are 0-190 and 220-410, respectively, whereas the ranges of the bottom and the top of the descent line 182 are 220-410 and 0-190. Thus, the mask in the eye diagram can be definitely obtained as an important basis of jitter analysis.

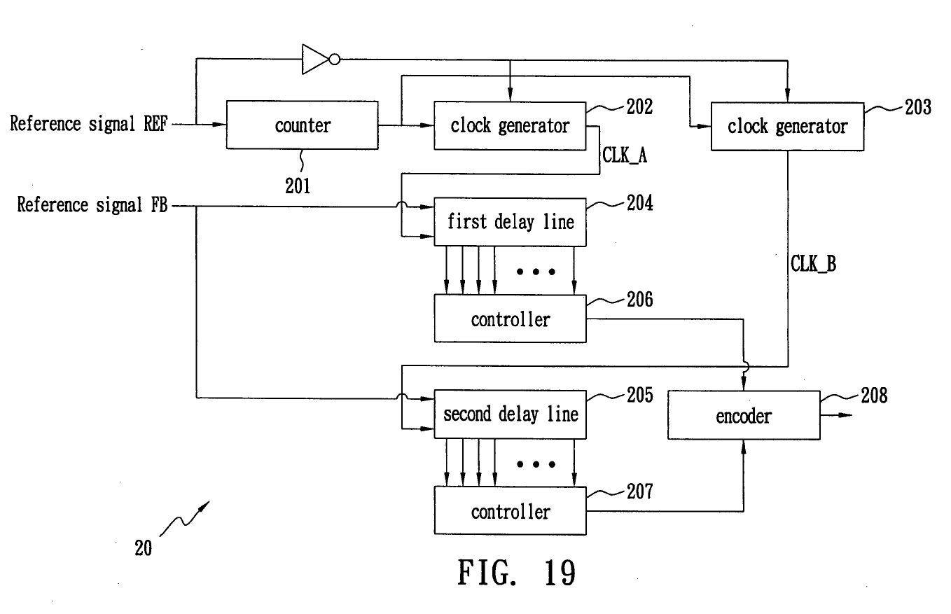

FIG. 19 shows the measuring device 20 for signal jitter of another embodiment of this invention to specify design and operation of the delay line. The signal jitter measuring device 20 comprises a counter 201, clock generators 202 and 203, a first delay line 204, a second delay line 205, controllers 206 and 207, and an encoder 208. The counter 201 receives a reference signal REF that goes through the clock generators 202 and 203 so as to generate clocks CLK_A and CLK_B. Then, CLK_A and CLK_B are sent to the first delay line 204 and the second delay line 205, respectively. A data signal FB is sent to the first and second delay line 204 and 205 to be quantified. The data signal FB is inputted to the encoder 208 through the controllers 206 and 207 to calculate the high and low level widths of the data signal FB. The delay lines 204 and 205 have several stages of delay function, and the structures in detail are described as follows

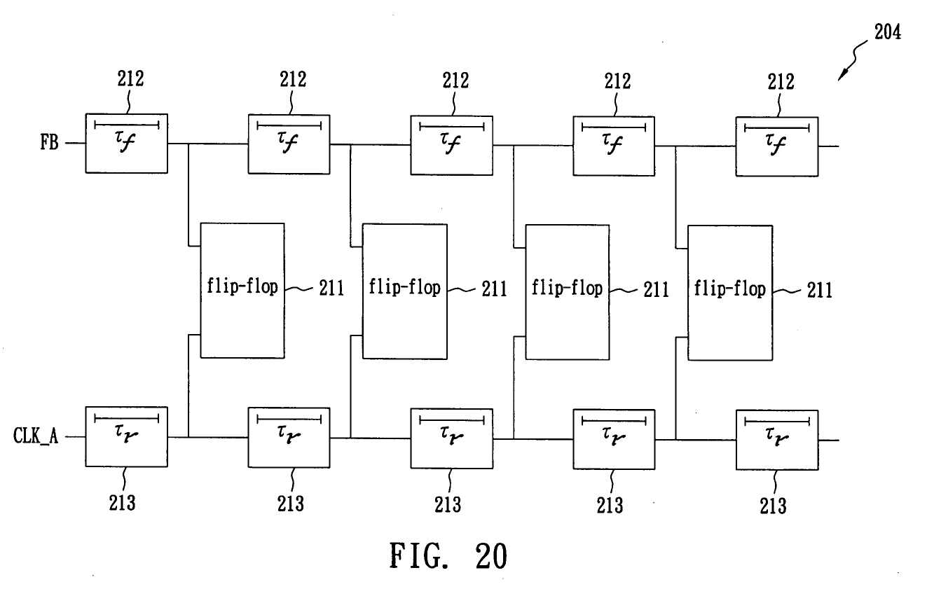

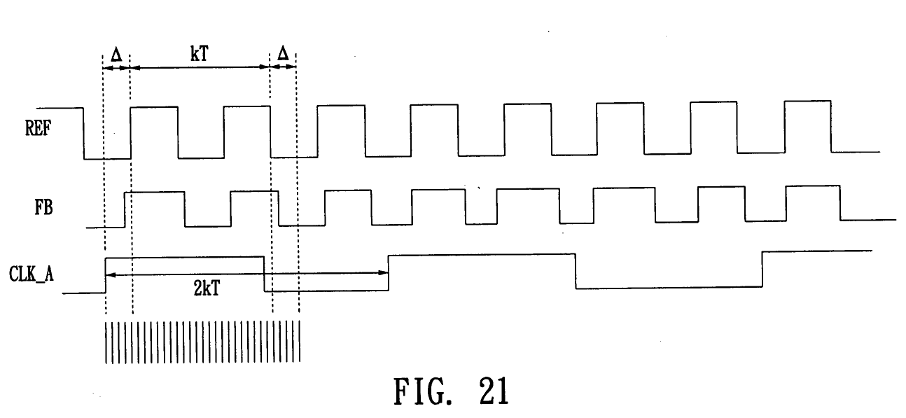

Referring to FIG. 20, the first delay line 204 in FIG. 19 essentially consists of several flip-flops 211 and several buffers 212 and 213 connected together. A delay block is formed by each flip-flop 211 as well as a buffer 212 and a buffer 213 in parallel to provide a stage of delay. The delay of each buffer 212 for receiving data signal FB on the upper row is τᵣ, whereas each buffer 213 on the lower row receives the clock CLK_A with delay τᵣ, where τᵣ>τ_{f}. With the increase of the stage number of the delay of the flip-flops 211, the ascent and descent edges of the clock CLK_A and the signal FB will overlap finally. Referring to FIG. 21, using an example for dividing k multiple frequency, given that T is the period of data signal FB, the period of CLK_A will be 2kT and three times that of the reference signal REF. Accordingly, if N is the stage number of delay, Nτᵣ must be lower than 2kT to avoid entering into another pulse cycle and interfering with the input of the next signal pulse. In addition, τᵣ−τ_{f} is equivalent to measuring scale, therefore the signal can be quantified only when N(τᵣ−τ_{f}) is greater than or equal to the sum of kT and the time difference Δ of the ascent edges between REF and CLK_A. This condition can be expressed with the following formulae (4) and (5):
Nτᵣ<2kT (4)
N(τᵣ−τ_{f})≧kT+2Δ (5)

The first and second delay lines 204 and 205 are outputted to the encoder 208 at the ascent edge and the descent edge of the reference signal, respectively.

If τᵣ is 90 ps, τ_{f} is 70 ps, and τᵣ−τ_{f} as resolution index is 20 ps. If the data rate is 500 MHz, the data period T is 2 ns. When dividing the frequency by 3 (k=3), the required stage number N of delay is (2 ns×3+1 ns×2)/20 ps=400, so that 400 flip-flops and 400 associated buffer sets are required. According to formula (1), the greatest delay time Nτᵣ=400×90 ps=36 ns is not lower than 2kT=2×3×2 ns=12 ns, which means the period of clock CLK_A; therefore, further treatment such as increasing k value or pipelining, etc., is necessary.

Internal structure of the second delay line 205 is essentially equivalent to the first delay line 204; thus, no repetition is offered here.

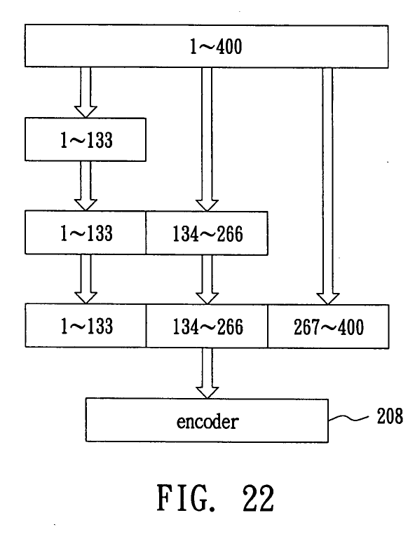

Referring to FIG. 22, based on the above example, when the τᵣ is 90 ps, data in 133 stages delay can be held within each 12 ns; therefore, data in 400 stages of delay can be divided into three segments, 1˜133, 134˜266 and 267˜400, in which data in stages 1˜133 need to be delayed three times, data in stages 134˜266 need to be delayed twice, and data in stages 267˜400 need to be delayed once, and each delay is 12 ns. Then, all the data are sent to the encoder 208. The above procedures of signal segmentation delay are the so-called pipeline technology that can avoid collisions between reference signals and clocks.

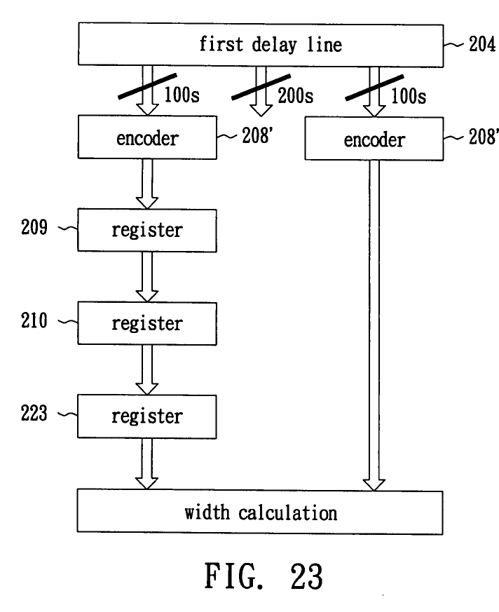

The above-mentioned pipeline is executed between the delay lines and the encoder; however, the pipeline can also be executed after the encoder, as shown in FIG. 23. Similarly, in the case of 400 data, since the influential factor on the width lies in the time points at the ascent and the descent edge of the signal in the front segment and the back segment, that the data in the middle can be omitted and only 100 signals in the first segment and 100 signals in the back segment need to be considered. In addition, after binary bit encoding by the encoder 208′ (sub-encoder contained in the encoder 208), the 400 signals can be represented by only 9 bits (2⁹>400) so as to significantly reduce the required number of flip-flops and buffers. The first 100 data have to be delayed three times, and the data delayed the first, second and third times can be stored in buffers 209, 210 and 223, respectively, and then widths are synchronously calculated after inputting the last 100 data. The first and last 100 signals can be expressed with 7 bits (2⁷>100); therefore, only 14 flip-flops are required in all to largely reduce hardware costs.

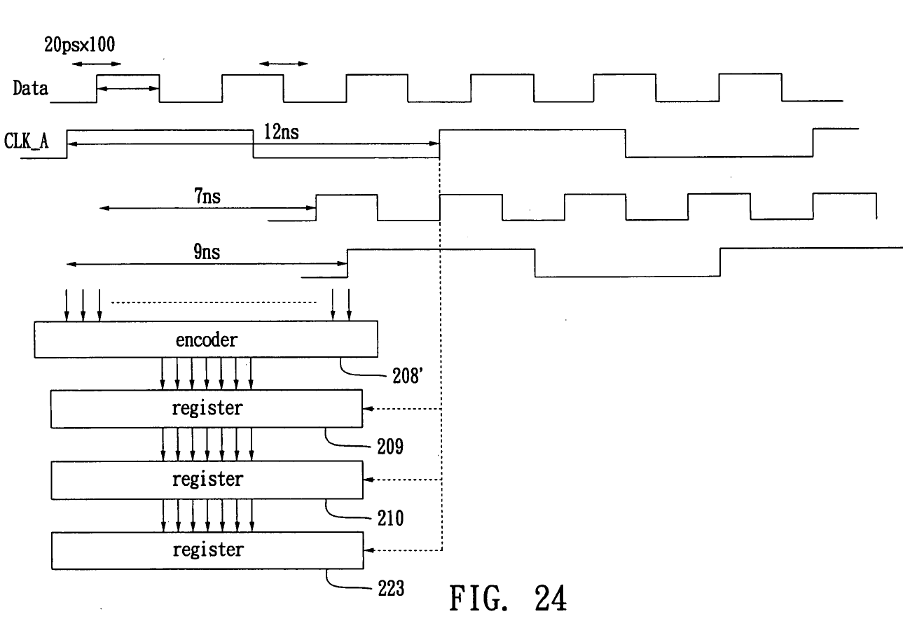

Referring to FIG. 24, using τᵣ of 90 ps as an example, the delay time for the first 100 stages delay is 9 ns, which is still less than 12 ns, so that three delays can be performed directly, whereas data of the last 100 stages is delayed once. Then, their widths are calculated simultaneously, and 200 signals in the middle are ignored. Data in the first 100 stages delay will produce 7 signals after being encoded by the encoder 208′, and the data after three delays will be stored in the buffers 209, 210 and 223.

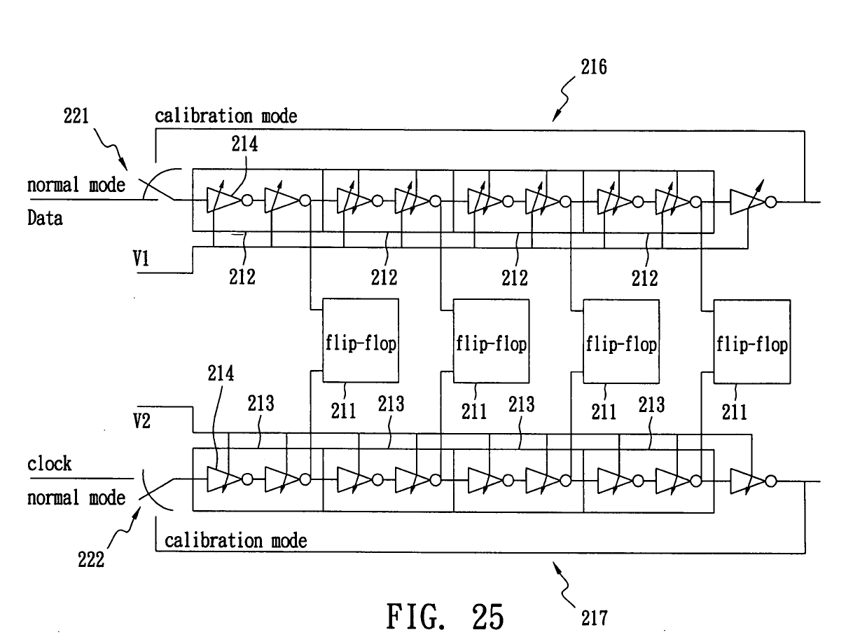

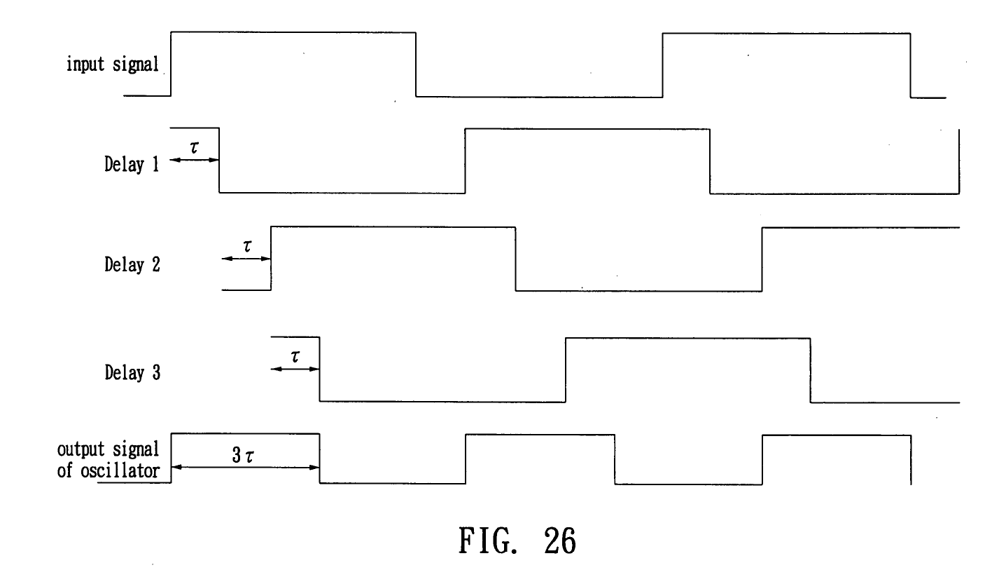

Referring to FIG. 25, each flip-flop 211 is connected to the buffers 212 associated with the data signal and to the buffers 213 associated with the reference signal, where each buffer 212 and 213 consists of two inverters 214. V1 and V2 are control signals of the inverters 214 on the upper and lower rows respectively. Calibration of the delay line strings an odd number of flip-flops 214 associated with the data signal into a loop to form an oscillator 216, and strings an odd number of flip-flops 214 associated with the clock signal into a loop to form another oscillator 217. If there are n inverters 214 in the oscillator 216 or 217, and delay of each inverter 214 is τ, nτ will be the half-period of the output signals of the oscillator 216 or 217. Therefore, the delay τ can be obtained by dividing the half-period of the output signal of the oscillator 216 or 217 by n (the number of the inverters 214) so as to conduct calibration by adjusting voltage. A normal mode and a calibration mode of the oscillator 216 are switched by a switch 221, whereas the mode switch of oscillator 217 is carried out by another switch 222. As shown in FIG. 26, if the oscillator comprises three inverters, the half-period of the output signal of the oscillator is 3τ, where delays 1, 2 and 3 are outputs of inverters 1, 2 and 3 that receive an input signal.

The above-described embodiments of the present invention are intended to be illustrative only. Numerous alternative embodiments may be devised by those skilled in the art without departing from the scope of the following claims.

What is claimed is:

1. A method for measuring signal jitters, comprising the steps of:
providing a first data signal;
generating a second data signal, wherein the frequency of the first data signal is a multiple of that of the second data signal, and the second data signal is aligned with the first data signal at the ascent and descent edges;
accumulating widths of the high and low levels of the second data signal;
generating an estimated jitter stream including estimated values of the second data signal at the ascent and descent edges based on the widths of the high and low levels of the second data signal;
establishing jitter distribution diagrams of the ascent and descent edges; and
calculating an eye open value based on the jitter distribution diagrams.

2. The method for measuring signal jitters in accordance with claim 1, wherein the widths of the high and low levels of the second data signal are measured by two clock signals, and the widths of the two clocks respectively cover the high and low levels of the second data signal.

3. The method for measuring signal jitters in accordance with claim 2, wherein the duty cycles of the two clock signals are (k+1)/2k and (k−1)/2k, if the frequency of the first data signal is k-fold of that of the second data signal.

4. The method for measuring signal jitters in accordance with claim 1, wherein the estimated jitter stream alternately represents the estimated jitter values at the ascent and descent edges.

5. The method for measuring signal jitters in accordance with claim 1, wherein the frequency of the first data signal is an odd multiple of that of the second data signal.

6. The method for measuring signal jitters in accordance with claim 1, wherein the jitter distribution diagrams are histograms.

7. The method for measuring signal jitters in accordance with claim 1, wherein the eye open is calculated by finding a standard deviation corresponding to a bit error rate.

8. The method for measuring signal jitters in accordance with claim 1, further comprising the following steps:
selecting high and low boundary detection threshold values of the second data signal;
generating jitter distribution diagrams at ascent and descent edges based on the high and low boundary detection threshold values; and
calculating the ranges of the jitter distribution diagrams at ascent and descent edges as the ranges of the tops and the bottoms of an ascent line and a descent line.

9. The method for measuring signal jitters in accordance with claim 8, wherein the ranges of the jitter distribution diagram based on the high boundary detection threshold value are equivalent to the ranges of the tops of the ascent line and the descent line, whereas the ranges of the jitter distribution diagram based on the low boundary detection threshold value are equivalent to the ranges of the bottoms of the ascent line and the descent line.

10. The method for measuring signal jitters in accordance with claim 1, wherein the conversion between the first data signal and the second data signal is performed through delay lines.

11. The method for measuring signal jitters in accordance with claim 10, wherein the delay line comprises a step of converting the first data signal into the second data signal by pipelining a reference signal.

12. The method for measuring signal jitters in accordance with claim 11, wherein the reference signal generates two clock signals to measure widths of the high and low levels of the second data signal.

13. The method for measuring signal jitters in accordance with claim 12, wherein the pipelining meets the following requirements:
Nτᵣ<2kT;
N(τᵣ−τ_{f})≧kT+2Δ;
wherein τᵣ is the delay time at each delay stage of the reference signal;
τ_{f} is the delay time at each delay stage of the first data signal;
N is the number of delay stages;
k is a multiple of the frequency of the first data signal to the second data signal;
T is the period of the first data signal; and
Δ is the time difference between the reference signal and the ascent edge of the clock signals.

14. The method for measuring signal jitters in accordance with claim 11, wherein the second data signal is encoded so as to calculate widths of the high and low levels of the second data signal.

15. The method for measuring signal jitters in accordance with claim 11, wherein the first data signal is encoded before pipelining.

16. The method for measuring signal jitters in accordance with claim 10, wherein the delay lines function as oscillators for calibration, and each oscillator comprises a plurality of inverters serially connected as a loop.

17. The method for measuring signal jitters in accordance with claim 16, wherein the calibration of the delay lines comprises the following steps:
switching the delay lines to a calibration route;
measuring the period of the oscillator;
dividing half of the period by the number of the inverters to obtain the delay time for each delay stage;
adjusting control voltage according to the delay time.

18. The method for measuring signal jitters in accordance with claim 1, wherein the estimated jitter values of the estimated jitter stream are obtained through subtracting the widths of the high and low levels of the second data signal by the mean of the widths of the high and low levels.

19. An apparatus for measuring signal jitters, comprising:
two delay lines coupled in parallel for delaying a first data signal so as to generate a second data signal, wherein the frequency of the first data signal is a multiple of that of the second data signal, and the second data signal is aligned with the first data signal at the ascent and descent edges; and
at least one encoder for calculating the widths of high level and low level of the second data signal.

20. The apparatus for measuring signal jitters in accordance with claim 19, comprising two encoders and further comprising a latch for alternately capturing the outputs of the two encoders.

21. The apparatus for measuring signal jitters in accordance with claim 19, further comprising a plurality of registers coupled between the delay lines and the encoder to temporarily store data for pipelining.

22. The apparatus for measuring signal jitters in accordance with claim 19, wherein the encoder is connected to the output ends of the delay lines.

23. The apparatus for measuring signal jitters in accordance with claim 22, further comprising a plurality of registers connected to the output ends of the encoder to temporarily store data for pipelining.

24. The apparatus for measuring signal jitters in accordance with claim 19, further comprising:
a modulator configured to generate a first clock signal input to one of the two delay lines;
a delay cell configured to delay the first clock signal to generate a second clock input to the other delay line;
wherein pulse widths of the first and second clock signals cover the high and low levels of the second data signal for calculating widths of the high and low levels of the second data signal by the encoder.

25. The apparatus for measuring signal jitters in accordance with claim 24, wherein the modulator further generates a third clock signal for controlling the data capture of the latch.

26. The apparatus for measuring signal jitters in accordance with claim 19, wherein at least one delay line is a gradient delay line.

27. The apparatus for measuring signal jitters in accordance with claim 19, wherein each delay line comprises a plurality of inverters and a plurality of buffers.

28. The apparatus for measuring signal jitters in accordance with claim 19, wherein each delay line comprises a plurality of delay sets connected in series, each delay set comprises:
a first buffer that receives the first data signal;
a second buffer that receives a clock signal; and
a flip-flop connected to the first and second buffers in parallel.

29. The apparatus for measuring signal jitters in accordance with claim 28, wherein the first buffers of the plurality of delay sets are connected in series as a loop, and the loop uses a switch to change the route.

30. The apparatus for measuring signal jitters in accordance with claim 29, wherein the number of the first buffers is an odd number.

31. The apparatus for measuring signal jitters in accordance with claim 28, wherein the second buffers of the plurality of delay sets are connected in series as a loop, and the loop uses a switch to change the route.

32. The apparatus for measuring signal jitters in accordance with claim 31, wherein the number of the second buffers is an odd number.
